(19) United States
(12) Patent Application Publication
(10) Pub. No.: US 2023/0352015 A1
(43) Pub. Date: Nov. 2, 2023

(54) USER TERMINAL, METHOD OF CONTROLLING USER TERMINAL, AND DIALOGUE MANAGEMENT METHOD

(71) Applicants: Hyundai Motor Company, Seoul (KR); Kia Corporation, Seoul (KR)

(72) Inventors: Sungwang KIM, Seoul (KR); Jaemin MOON, Yongin-Si (KR); Minjae PARK, Seongnam-Si (KR)

(73) Assignees: Hyundai Motor Company, Seoul (KR); Kia Corporation, Seoul (KR)

(21) Appl. No.: 18/106,888

(22) Filed: Feb. 7, 2023

(30) Foreign Application Priority Data
Apr. 29, 2022 (KR) 10-2022-0053817

(51) Int. Cl. G10L 15/22; G10L 15/18; G10L 15/30; H04M 3/493

(52) U.S. Cl. CPC G10L 15/22; G10L 15/1815; G10L 15/30; H04M 3/4936; G10L 2015/088

(57) ABSTRACT

A user terminal includes a microphone through which a speech of a user is input, a speaker through which a speech of a counterpart is output during a call, a controller configured to activate a speech recognition function upon receiving a trigger signal during the call, and a communicator configured to transmit, after the trigger signal is input, information related to the user's speech which is input through the microphone and information related to content of the call to a dialogue system that is configured to perform the speech recognition function, wherein the controller is configured to control the speaker to output a system response transmitted from the dialogue system.

### CROSS-REFERENCE TO RELATED APPLICATION

The present application claims priority to Korean Patent Application No. 10-2022-0053817, filed on Apr. 29, 2022, the entire contents of which is incorporated herein for all purposes by this reference.

### BACKGROUND OF THE PRESENT DISCLOSURE

### Field of the Present Disclosure

The present disclosure relates to a user terminal that allows a user to use a speech recognition function during a call, a method of controlling the user terminal, and a dialogue management method.

### Description of Related Art

A dialogue system is a device capable of identifying a user's intention through a dialogue with the user. Such a dialogue system is connected to various electronic devices used in daily life, such as vehicles, mobile devices, home appliances, and the like, to allow various functions corresponding to the user's speech to be performed.

An electronic device connected to a dialogue system may include a microphone, and a user may input a voice command through the microphone provided in the electronic device.

Meanwhile, among electronic devices connected to a dialogue system, a mobile device or a vehicle may perform a call function, and while the call function is performed, a user's voice input into a microphone is not transmitted to the dialogue system but to a call counterpart.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a user terminal that allows a user to conveniently use a speech recognition function as necessary even during a call and that provides a system response reflecting content of the call of the user, a method of controlling the user terminal, and a dialogue management method.

In accordance with one aspect of the present disclosure, a user terminal includes a microphone through which a speech of a user is input, a speaker through which a speech of a counterpart is output during a call, a controller configured to activate a speech recognition function upon receiving a trigger signal during the call, and a communicator configured to transmit, after the trigger signal is input, information related to the user's speech which is input through the microphone and information related to content of the call to a dialogue system that is configured to perform the speech recognition function, wherein the controller is configured to control the speaker to output a system response transmitted from the dialogue system.

The user terminal may further include a storage configured to store the information related to the content of the call.

The information related to the content of the call may include the user's speech and the counterpart's speech that are input during the call.

The storage may be configured to store the information related to the content of the call in a form of an audio signal.

The user terminal may further include a speech recognition module configured to convert the user's speech and the counterpart's speech that are input during the call into text.

The storage may be configured to store the information related to the content of the call in a form of text.

The system response for the content of the call may be generated based on the information related to the content of the call and the user's speech which is input through the microphone after the trigger signal is input.

The communicator may transmit the user's speech to the counterpart through a first channel and transmit the user's speech to the dialogue system through a second channel.

Upon receiving the trigger signal, the controller may close the first channel so that the user's speech input through the microphone is not transmitted to the counterpart.

The trigger signal may include a predetermined specific word spoken by the user to the counterpart during the call.

The controller may transmit the information related to the content of the call stored within a predetermined time period based on a time point at which the speech recognition function is activated to the dialogue system through the communicator.

In a case in which the system response is related to the content of the call, the controller may be configured to control the communicator to transmit the system response to the counterpart.

The controller may be configured to control the communicator to transmit the system response to the counterpart according to the user's selection.

In accordance with another aspect of the present disclosure, a method of controlling a user terminal includes receiving a speech of a user through a microphone, outputting, through a speaker, a speech of a counterpart during a call, storing information related to content of the call, activating a speech recognition function upon receiving a trigger signal during the call, transmitting, after the trigger signal is input, information related to the user's speech which is input through the microphone and information related to content of the call to a dialogue system that is configured to perform the speech recognition function, and controlling the speaker to output a system response transmitted from the dialogue system.

The information related to the content of the call may include the user's speech and the counterpart's speech that are input during the call.

The storing of the information related to the content of the call may include storing the information related to the content of the call in a form of an audio signal.

The storing of the information related to the content of the call may include converting the user's speech and the counterpart's speech that are input during the call into text and storing the information related to the content of the call in a form of text.

The system response for the content of the call may be generated based on the information related to the content of the call and the user's speech which is input through the microphone.

The method may further include transmitting the user's speech input through the microphone during the call to the counterpart through a first channel of the communicator, wherein the transmitting of the information to the dialogue system that is configured to perform the speech recognition function may include closing the first channel and transmitting the user's speech to the dialogue system through a second channel of the communicator.

The trigger signal may include a predetermined specific word spoken by the user to the counterpart during the call.

The transmitting of the information to the dialogue system that is configured to perform the speech recognition function may include transmitting the information related to the content of the call stored within a predetermined time period based on a time point at which the speech recognition function is activated to the dialogue system through the communicator.

The method may further include, in a case in which the system response is related to the content of the call, transmitting the system response to the counterpart through the communicator.

The method may further include receiving a user's selection as to whether to transmit the system response to the counterpart, and transmitting the system response to the counterpart through the communicator based on the user's selection.

In accordance with yet another aspect of the present disclosure, a dialogue management method includes receiving, from a user terminal, information related to content of a call between a user and a counterpart, predicting an intention of the user based on the information related to the content of the call, proactively generating a system response corresponding to the predicted intention of the user, transmitting the system response to the user terminal, upon receiving a speech of the user related to the system response from the user terminal after the call ends, generating a new system response corresponding to the received speech of the user, and transmitting the new system response to the user terminal.

Upon ending the call, the user terminal may activate a speech recognition function.

The method may further include, after the call ends, determining whether the speech of the user received from the user terminal is related to the system response.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram illustrating an operation of a dialogue system according to an exemplary embodiment of the present disclosure;

FIG. 2 is a block diagram illustrating an operation of a user terminal according to an exemplary embodiment of the present disclosure;

FIG. 3 is a diagram illustrating a mutual relationship between a dialogue system and a user terminal according to an exemplary embodiment of the present disclosure;

FIG. 4 is a flowchart illustrating an example of a method of controlling a user terminal and a dialogue management method according to an exemplary embodiment of the present disclosure;

FIG. 5 is a block diagram illustrating an operation of a user terminal according to an exemplary embodiment of the present disclosure;

FIG. 6 is a diagram illustrating channels through which a user's voice input to a user terminal is transmitted to a call counterpart and a dialogue system according to an exemplary embodiment of the present disclosure;

FIG. 7 is a diagram illustrating a specific example in which a user of a user terminal utilizes a speech recognition function while a call function is performed according to an exemplary embodiment of the present disclosure;

FIG. 8 is a diagram illustrating a specific example in which a user of a user terminal utilizes a speech recognition function while a call function is performed according to an exemplary embodiment of the present disclosure;

FIG. 9 is a diagram illustrating a specific example in which a user of a user terminal utilizes a speech recognition function while a call function is performed according to an exemplary embodiment of the present disclosure;

FIG. 10 is a diagram illustrating a specific example in which a user of a user terminal utilizes a speech recognition function while a call function is performed according to an exemplary embodiment of the present disclosure;

FIG. 11 is a flowchart illustrating another example of the method of controlling the user terminal and the dialogue management method according to the embodiment;

FIG. 12 is a diagram illustrating a specific example in which a system response is proactively provided while a user of a user terminal utilizes a call function according to an exemplary embodiment of the present disclosure; and

FIG. 13 is a diagram illustrating a specific example in which a system response is proactively provided while a user of a user terminal utilizes a call function according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Embodiments described in the present specification and configurations illustrated in the accompanying drawings are only exemplary examples of the present disclosure. It should be understood that the present disclosure covers various modifications that can substitute for the exemplary embodiments herein and drawings at a time of filing of the present application.

Furthermore, like reference numerals or designations in the accompanying drawings may refer to like parts or components performing substantially the same function.

Furthermore, it should be understood that the terminology used herein is for describing the exemplary embodiments only and is not intended to limit the present disclosure. As used herein, the singular forms “a” and “an” are intended to include the plural forms as well, unless the context clearly indicates otherwise.

In the present specification, it should be understood that the terms “comprise,” “comprising,” “include,” and/or “including,” when used herein, specify the presence of stated features, integers, steps, operations, elements, parts, and/or combinations thereof, but do not preclude the presence or addition of one or more other features, integers, steps, operations, elements, parts, and/or combinations thereof.

Furthermore, it should be understood that, although the terms “first,” “second,” and the like may be used herein to describe various elements, these elements are not limited by these terms. These terms are only used to distinguish one element from another element. For example, a first element could be termed a second element, and similarly, a second element could be termed a first element without departing from the scope of the present disclosure.

As used herein, the term “and/or” includes any and all combinations of one or more of the associated listed items.

Moreover, terms described in the specification such as “part,” “unit,” “block,” “member,” “module,” and the like may refer to a unit that processes at least one function or operation. For example, the above terms may refer to at least one piece of hardware such as a field-programmable gate array (FPGA), an application specific integrated circuit (ASIC), and the like, at least one piece of software stored in a memory, or at least one process processed by a processor.

In each step, identification codes are used to identify each step and do not describe the order of the steps, and each step may be performed differently from the stated order unless explicitly stated in the context.

The expression “at least one of” used when referring to a list of elements in the present specification may change a combination of elements. For example, it may be understood that the expression “at least one of a, b, and c” refers to only a, only b, only c, both a and b, both a and c, both b and c, or a combination of a, b, and c.

Hereinafter, embodiments of the present disclosure will be described in detail with reference to the accompanying drawings.

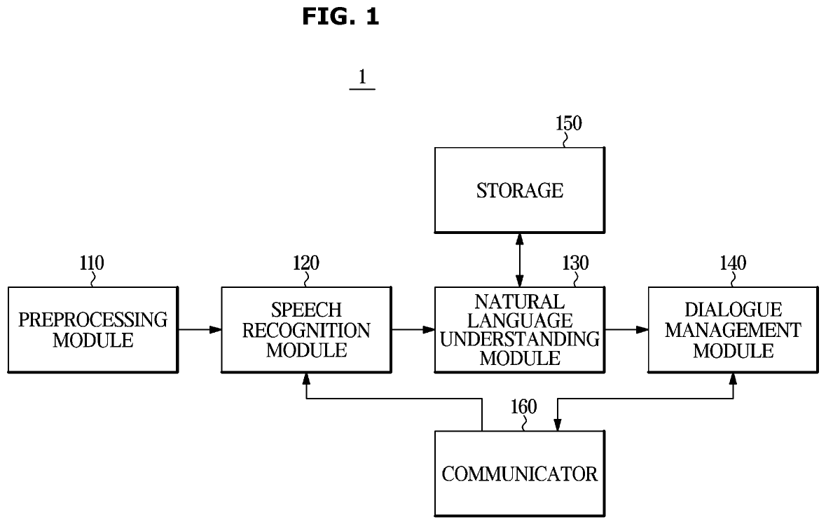

FIG. 1 is a block diagram illustrating an operation of a dialogue system according to an exemplary embodiment of the present disclosure.

Referring to FIG. 1, a dialogue system 1 according to the exemplary embodiment of the present disclosure includes a preprocessing module 110 that performs preprocessing, such as noise removal or the like, on a user's speech, a speech recognition module 120 that converts the user's speech into text, a natural language understanding module 130 that classifies a domain or intent for the user's speech based on the converted text and performs entity extraction and slot tagging, a dialogue management module 140 that generates a system response corresponding to the user's speech based on an output of the natural language understanding module 130, a communicator 160 that communicates with a user terminal, and a storage 150 for storing information necessary for performing an operation to be described below.

The preprocessing module 110 may perform noise removal on the user's speech transmitted in a form of an audio signal, and may detect a voice section including the actual user's speech from the transmitted audio signal by applying end-point detection (EPD) technology to the audio signal.

The speech recognition module 120 may be implemented as a speech to text (STT) engine, and may convert the user's speech into text by applying a speech recognition algorithm to the user's speech.

For example, the speech recognition module 120 may extract a feature vector from the user's speech by applying feature vector extraction technology such as cepstrum, linear predictive coefficient (LPC), mel-frequency cepstral coefficient (MFCC), or filter bank energy to the user's speech.

Then, the extracted feature vector may be compared with a trained reference pattern to obtain a recognition result. To the present end, an acoustic model that models and compares signal characteristics of speech or a language model that models a linguistic order relationship between words, syllables, or the like corresponding to recognized vocabularies may be used.

Furthermore, the speech recognition module 120 may convert the user's speech into text based on a learning model trained by machine learning or deep learning. In the exemplary embodiment of the present disclosure, because there is no limitation on the method in which the speech recognition module 120 converts the user's speech into text, the speech recognition module 120 may convert the user's speech into text by applying various speech recognition techniques to the user's speech other than the above-described method.

The natural language understanding module 130 may apply natural language understanding (NLU) technology to determine the user's intention included in the text. Therefore, the natural language understanding module 130 may include an NLU engine that determines the user's intention by applying the NLU technology to an input sentence. Here, the text output by the speech recognition module 120 may be an input sentence input to the natural language understanding module 130.

For example, the natural language understanding module 130 may recognize a named entity from the input sentence. The named entity is a proper noun such as a person's name, a place name, an organization name, time, date, money, etc. Named entity recognition (NER) is a task of identifying an entity name in a sentence and determining a type of the identified entity name. Important keywords may be extracted from a sentence through named entity recognition so that the meaning of the sentence may be understood.

Furthermore, the natural language understanding module 130 may determine a domain from the input sentence. The domain is used to identify a subject of the user's speech. For example, a domain representing one of various subjects such as vehicle control, schedules, provision of information on weather or traffic conditions, text transmission, navigation, music, and the like may be determined based on the input sentence.

Furthermore, the natural language understanding module 130 may classify intent corresponding to the input sentence, and may extract an entity required to perform the corresponding intent.

For example, when the input sentence is “Turn on the air conditioner,” the domain may be [vehicle control], the intent may be [turn on_air conditioner], and the entity required to perform the control corresponding to the intent may be [temperature, wind volume].

However, terms used and their definitions may be different for each dialogue system. Therefore, even when a term different from that in the exemplary embodiment of the present disclosure is used, when the meaning thereof or a role in the dialogue system is the same or similar, it may be included in the scope of the present disclosure.

An operation of extracting, by the natural language understanding module 130, necessary information, such as intent, a domain, and an entity, from the input sentence may be performed using a learning model based on machine learning or deep learning.

The dialogue management module 140 may generate a system response corresponding to the user's speech to provide a service corresponding to the user's intention. The system response may include a system speech output as a response for the user's speech, and a signal for executing the intent corresponding to the user's speech.

Furthermore, the dialogue management module 140 may include a natural language generator (NLG) engine and a text-to-speech (TTS) engine to generate a system speech.

Meanwhile, as will be described below, the dialogue management module 140 may proactively generate and output a system response based on content of a call between the user and a counterpart before the user's speech is input.

The communicator 160 may wirelessly communicate with a base station or an access point (AP), and may transmit or receive data to or from external devices through the base station or the AP.

For example, the communicator 160 may wirelessly communicate with the AP using WiFi™ (IEEE 802.11 technology standard) or may communicate with the base station using Code Division Multiple Access (CDMA), wide CDMA (WCDMA), Global System for Mobile Communications (GSM), Long-Term Evolution (LTE), Fifth-Generation (5G) technology, Wireless Broadband (WiBro), or the like.

Various types of information needed to perform the operations described above and operations to be described below may be stored in the storage 150. For example, information related to the content of the call between the user and the counterpart, which is provided from the user terminal, may be stored in the storage 150. A detailed description related thereto will be provided below.

The storage 150 may include at least one of various types of memories such as a read only memory (ROM), a random-access memory (RAM), a flash memory, and the like.

The dialogue system 1 may include at least one memory in which a program for performing the operations described above and the operations to be described below is stored, and at least one processor for executing the stored program.

The speech recognition module 120, the natural language understanding module 130, and the dialogue management module 140 may each use a separate memory and processor or may share a memory and a processor.

That is, the speech recognition module 120, the natural language understanding module 130, and the dialogue management module 140 are each divided based on the operation and do not represent physically separated components. Therefore, any component as long as it can perform the operation of the speech recognition module 120, the natural language understanding module 130, or the dialogue management module 140 described above or to be described below may be included in the scope of the present disclosure regardless of the name referring thereto.

Furthermore, as the storage 150, a separate memory different from the memory in which the program for performing the operations of the speech recognition module 120, the natural language understanding module 130, and the dialogue management module 140 is stored may be used, or the same memory may be shared.

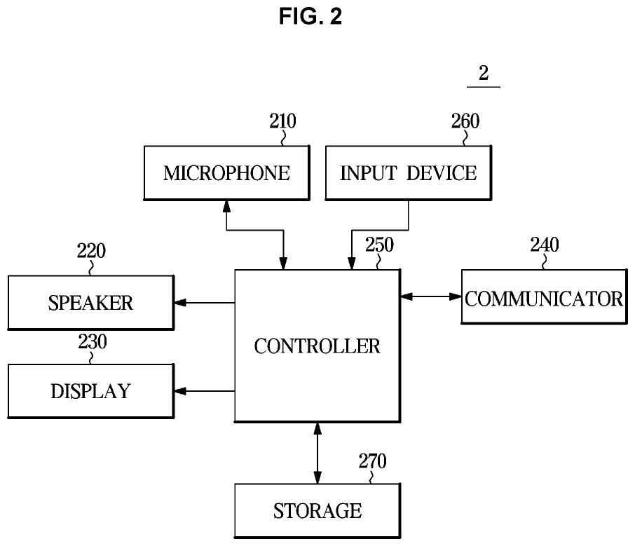

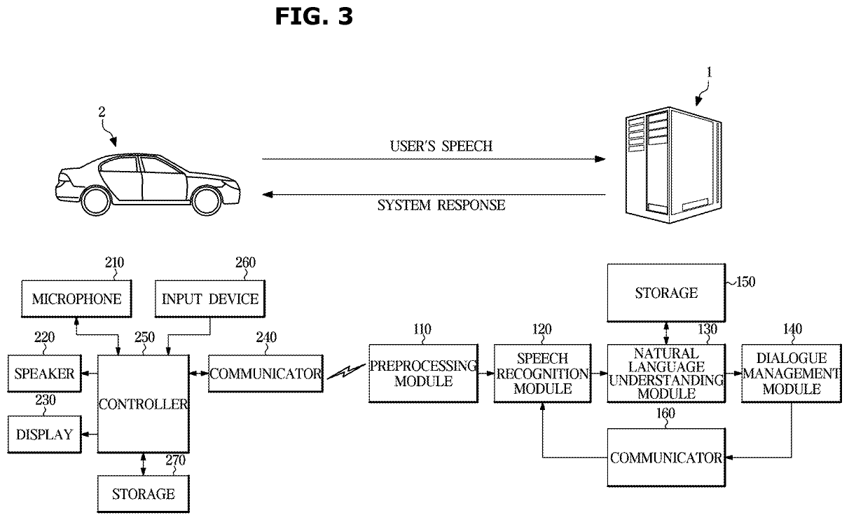

FIG. 2 is a block diagram illustrating an operation of a user terminal according to an exemplary embodiment of the present disclosure, and FIG. 3 is a diagram illustrating a mutual relationship between a dialogue system and a user terminal according to an exemplary embodiment of the present disclosure.

A user terminal 2 according to the exemplary embodiment of the present disclosure is configured as a gateway between a user and a dialogue system 1. For example, the user terminal 2 may include a mobile device such as a smartphone, a tablet personal computer (PC), a laptop PC, or the like, or a wearable device such as a smart watch, smart glasses, or the like.

Alternatively, the user terminal 2 may be a vehicle. In the instant case, the user's speech may be input through a microphone provided in the vehicle, and transmitted to the dialogue system 1 through a communicator provided in the vehicle.

Furthermore, when a system response is transmitted from the dialogue system 1, a process corresponding to the system response may be performed by controlling a speaker or display provided in the vehicle or controlling other components of the vehicle.

Referring to FIG. 2, the user terminal 2 may include a microphone 210, a speaker 220, a display 230, a communicator 240, a controller 250, an input device 260, and a storage 270.

The communicator 240 may include a wireless communicator that wirelessly transmits or receives data to or from external devices. Furthermore, the communicator 240 may further include a wired communicator that transmits or receives data to or from external devices through wires.

The wired communicator may transmit or receive data to or from external devices through a Universal Serial Bus (USB) terminal or an auxiliary (AUX) terminal.

The wireless communicator may wirelessly communicate with a base station or an AP, and may transmit or receive data to or from external devices through the base station or the AP.

For example, the wireless communicator may wirelessly communicate with the AP using WiFi™ (IEEE 802.11 technology standard), or may communicate with the base station using CDMA, WCDMA, GSM, LTE, 5G technology, WiBro, or the like.

Furthermore, the wireless communicator may directly communicate with external devices. For example, the wireless communicator may transmit or receive data to or from external devices in a short distance using Wi-Fi Direct, Bluetooth™ (IEEE 802.15.1 technology standard), ZigBee™ (IEEE 802.15.4 technology standard), or the like.

For example, when the user terminal 2 is implemented as a vehicle, the communicator 240 may communicate with a mobile device positioned inside the vehicle through Bluetooth communication to receive information (e.g., user's image, user's voice, contact information, schedule, etc.) which is obtained by the mobile device or stored in the mobile device. Furthermore, as will be described below, the vehicle may perform a call function using the mobile device.

The user's speech may be input through the microphone 210. When the user's speech is input, the microphone 210 converts the user's speech in a form of sound waves into an audio signal, which is an electrical signal, and outputs the converted audio signal. Therefore, the user's speech after being output from the microphone 210 may be processed in a form of the audio signal.

The speaker 220 may output various audios related to a system response received from the dialogue system 1. The speaker 220 may output a system speech transmitted from the dialogue system 1 or output a content signal corresponding to the system response.

Furthermore, audio of music, radio, or multimedia content may be output regardless of the system response, or audio for route guidance while a navigation function is performed may be output.

Meanwhile, the user terminal 2 may perform a call function. While the call function is performed, the user's speech input through the microphone 210 may be transmitted to a call counterpart through the communicator 240, and the call counterpart's speech transmitted through the communicator 240 may be output through the speaker 220.

When the user terminal 2 is a vehicle, a call function may be performed by the vehicle itself, or may be performed by a mobile device connected to the vehicle through the communicator 240.

In the instant case, the user terminal 2 may transmit the user's speech input through the microphone 210 to a mobile device connected through Bluetooth, and output the counterpart's speech transmitted from the mobile device through the speaker 220.

As described above, while the user terminal 2 performs the call function, the microphone 210 is used for a call. Therefore, although it is common that the use of a speech recognition function through input of a voice command is limited while the call function is performed, the user terminal 2 and the dialogue system 1 according to the exemplary embodiment enable smooth use of the speech recognition function while the user terminal 2 performs the call function. A description related thereto will be provided below.

The display 230 may display various pieces of information related to the system response received from the dialogue system 1. The display 230 may display the system speech transmitted through the speaker 220 as text, and when the user's selection of a plurality of items is required to execute an intent corresponding to the user's speech, may display the plurality of items as a list.

Furthermore, information required to perform other functions of the user terminal 2, such as outputting multimedia content and a navigation screen, and the like may be displayed regardless of the system response, and information for guiding a manual input through the input device 260 may be displayed.

The user terminal 2 may include an input device 260 for manually receiving a user's command in addition to the microphone 210. The input device 260 may be provided in a form of a button, a jog shuttle, or a touch pad. When the input device 260 is provided in a form of a touch pad, a touch screen may be implemented together with the display 230.

The input device 260 may include a push-to-talk (PTT) button used to activate a speech recognition function.

The controller 250 may control the components of the user terminal 2 so that the operations described above or the operations to be described below may be performed. The controller 250 may include at least one memory in which a program for controlling the components of the user terminal 2 is stored, and at least one processor for executing the stored program.

Various types of information necessary for the user terminal 2 to perform the operations described above and the operations to be described below may be stored in the storage 270. For example, information related to content of a call between the user and the counterpart may be stored in the storage 270. A detailed description related thereto will be provided below.

The storage 270 may include at least one of various types of memories such as an ROM, an RAM, a flash memory, and the like.

As illustrated in FIG. 3, the user's speech input through the microphone 210 of the user terminal 2 may be transmitted to the dialogue system 1 through the communicator 240.

When the communicator 160 of the dialogue system 1 receives the user's speech and the speech recognition module 120 and the natural language understanding module 130 output an analysis result for the user's speech, the dialogue management module 140 may generate an appropriate system response based on the analysis result for the user's speech, and transmit a system response to the user terminal 2 through the communicator 160.

The dialogue system 1 may be implemented as a server. In the instant case, the dialogue system 1 does not necessarily have to be implemented as one server, and may be implemented as a plurality of physically separated servers.

Alternatively, the speech recognition module 120 and the natural language understanding module 130 may be implemented as separate external systems. In the instant case, when the dialogue system 1 receives the user's speech from the user terminal 2, the dialogue system 1 may transmit the received user's speech to an external system and receive an analysis result for the user's speech from the external system.

The dialogue management module 140 of the dialogue system 1 may generate an appropriate system response corresponding to the user's speech based on the received analysis result and transmit the generated system response to the user terminal 2 through the communicator 160.

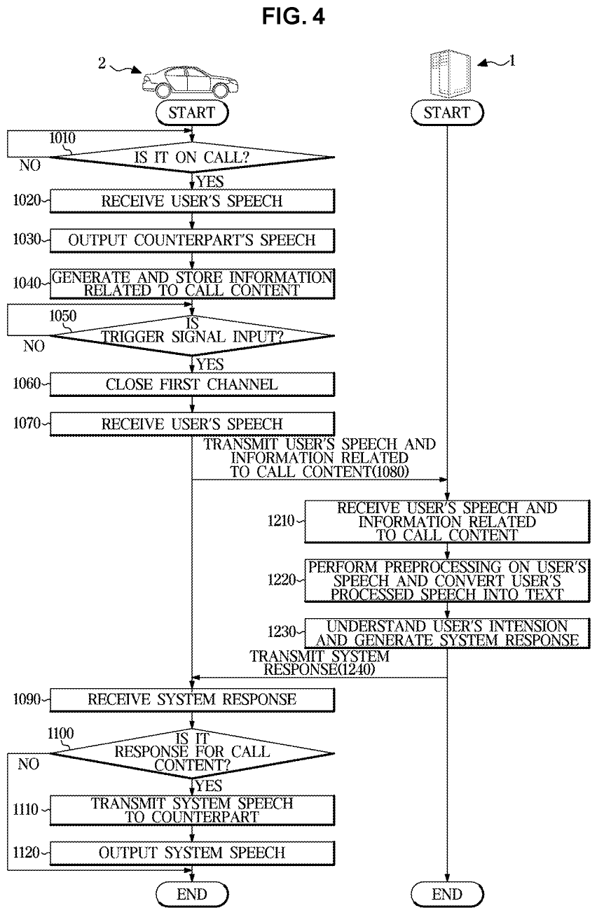

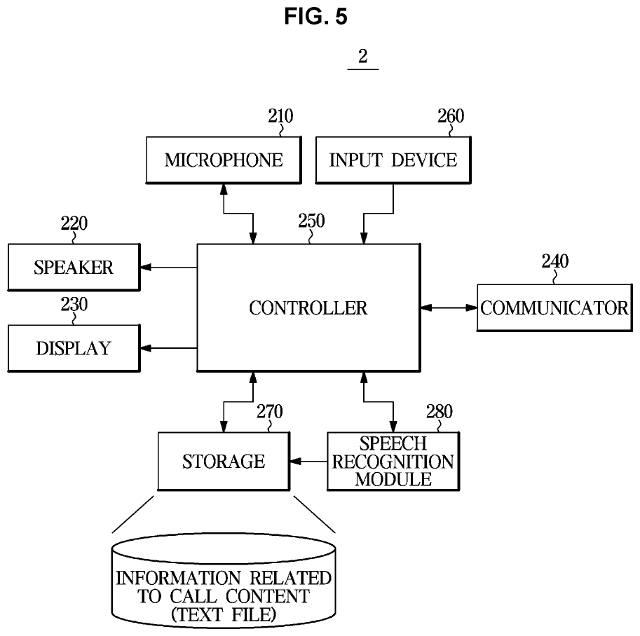

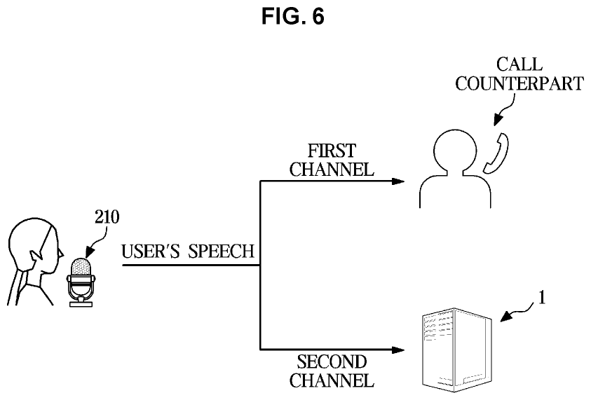

FIG. 4 is a flowchart illustrating an example of a method of controlling a user terminal and a dialogue management method according to an exemplary embodiment of the present disclosure, FIG. 5 is a block diagram illustrating an operation of a user terminal according to an exemplary embodiment of the present disclosure, and FIG. 6 is a diagram illustrating channels through which a user's voice input to a user terminal is transmitted to a call counterpart and a dialogue system according to an exemplary embodiment of the present disclosure.

In the method of controlling the user terminal according to the exemplary embodiment of the present disclosure, a control target thereof may be the user terminal 2 described above, and the dialogue management method according to the exemplary embodiment of the present disclosure may be performed by the dialogue system 1 described above. Therefore, the content described above with respect to the user terminal 2 may be applied to the method of controlling the user terminal even when there is no additional description, and the content described above with respect to the dialogue system 1 may be applied to the dialogue management method even when there is no additional description.

Furthermore, a description of the method of controlling the user terminal to be described below may be applied to the user terminal 2, and a description of the dialogue management method may be applied to the dialogue system 1.

In FIG. 4, the flowchart illustrated on the user terminal 2 side is a flowchart illustrating the method of controlling the user terminal, and the flowchart illustrated on the dialogue system 1 side is a flowchart illustrating the dialogue management method.

Referring to FIG. 4, when the user terminal 2 is performing a call function (YES in 1010), the microphone 210 receives the user's speech (1020) and the speaker 220 outputs the counterpart's speech (1030).

The user's speech input through the microphone 210 may be transmitted to the counterpart through the communicator 240, and when the communicator 240 receives the speech from the counterpart, the counterpart's speech may be output through the speaker 220.

When the user terminal 2 directly performs the call function, a communication target of the communicator 240 may become the counterpart's terminal, and when the user terminal 2 performs the call function through another electronic device connected thereto, an actual communication target of the communicator 240 may become the electronic device connected to the user terminal 2.

For example, when the user terminal 2 is a vehicle and a call function is performed through a mobile device connected to the vehicle through Bluetooth communication, the communicator 240 may transmit the user's speech input through the microphone 210 to the mobile device and receive the counterpart's speech transmitted from the mobile device. The mobile device may transmit the user's speech transmitted from the user terminal 2 to the counterpart's device and transmit the counterpart's speech transmitted from the counterpart's terminal to the user terminal 2.

Furthermore, the user terminal 2 may generate and store information related to the content of the call (1040).

The information related to the content of the call is information related to content of dialogues transmitted and received between the user and the counterpart during a call. As an exemplary embodiment of the present disclosure, the information related to the content of the call may be generated in a form of an audio file and stored in the storage 270. To the present end, the controller 250 may store the user's speech input through the microphone 210 and the counterpart's speech received through the communicator 240 in the storage 270 as audio files.

As an exemplary embodiment of the present disclosure, as illustrated in FIG. 5, the information related to the content of the call may be generated in a form of a text file and stored in the storage 270.

The user terminal 2 may further include a speech recognition module 280 that converts the speech into text. The speech recognition module 280 provided in the user terminal 2 may recognize a wake-up word for activating a speech recognition function or recognize a predetermined simple voice command.

However, because the performance of the speech recognition module 280 may vary according to design changes, the speech recognition module 280 may convert the user's speech input through the microphone 210 and the counterpart's speech received through the communicator 240 into text during the call. A text file including the converted text may be stored in the storage 270.

It is possible to store all audio signals or text since a time point at which the call starts, and it is also possible to automatically delete a certain amount of data when a certain time period has elapsed after the start of the call. For example, when 10 minutes have elapsed after the start of the call, all data excluding data recorded within 5 minutes after a current point of time may be deleted, and when 10 minutes have elapsed after a time point at which the deletion is performed, all data excluding data recorded within 5 minutes may also be deleted. That is, when a first time period has elapsed after the start of the call, an operation of deleting all information excluding information related to the content of the call stored within a second time period after the current point of time may be repeated every first time (first time period>second time period).

The user may wish to use the speech recognition function during the call. In the instant case, the user may input a trigger signal for activating the speech recognition function to the user terminal 2. The trigger signal may include a specific wake-up word input through the microphone 210 or include a speech recognition command input through the input device 260.

When the trigger signal for activating the speech recognition function is input (YES in 1050), the controller 250 closes a first channel so that the user's speech input through the microphone 210 is not transmitted to the counterpart (1060).

Furthermore, when the trigger signal is input, the speech recognition function may be activated. In the exemplary embodiment of the present disclosure, the activation of the speech recognition function may mean that speech recognition may be performed on the user's speech input through the microphone 210. That is, after the speech recognition function is activated, the user's speech input through the microphone 210 may be transmitted to the dialogue system 1, and the dialogue system 1 may analyze the transmitted user's speech, generate a system response corresponding thereto, and re-transmit the generated system response to the user terminal 2.

Referring to FIG. 6, the user's speech input through the microphone 210 may be transmitted to at least one of the call counterpart and the dialogue system 1 through the communicator 240.

In the exemplary embodiment of the present disclosure, a communication channel through which the user's speech input through the microphone 210 is transmitted to the call counterpart is referred to as a first channel, and a communication channel through which the user's speech input through the microphone 210 is transmitted to the dialogue system 1 is referred to as a second channel. The first channel and the second channel may employ the same communication method or employ different communication methods.

For example, when the user terminal 2 is a vehicle, the first channel through which the user's speech is transmitted to the call counterpart may employ a short-range communication method such as Bluetooth, and the second channel through which the user's speech is transmitted to the dialogue system 1 may employ a wireless communication method such as Wi-Fi, Fourth-Generation (4G) technology, 5G technology, or the like.

When the user terminal 2 is performing a call function, the first channel may be opened and the second channel may be closed. When the user terminal 2 is performing a speech recognition function, the first channel may be closed and the second channel may be opened.

Here, the opening of the first channel means that the user's speech input through the microphone 210 is transmitted to the call counterpart through the first channel, and the closing of the first channel means that the user's speech input through the microphone 210 is not transmitted to the call counterpart through the first channel.

Furthermore, the opening of the second channel means that the user's speech input through the microphone 210 is transmitted to the dialogue system 1 through the second channel, and the closing of the second channel means that the user's speech input through the microphone 210 is not transmitted to the dialogue system 1 through the second channel.

When the user is on a call using the user terminal 2, the first channel may be opened, and the user's speech input through the microphone 210 may be transmitted to the call counterpart through the first channel. However, when the user inputs a trigger signal during the call to use the speech recognition function (YES in 1050), the first channel may be closed (1060), and thus the user's speech input through the microphone 210 may be blocked so that the user's speech is not transmitted to the call counterpart.

The microphone 210 may receive the user's speech (1070), and the communicator 240 may transmit the user's speech and the information related to the content of the call to the dialogue system 1 through the second channel (1080).

It is possible to transmit all the stored information related to the content of the call, and it is also possible to transmit only the information related to the content of the call recorded within a predetermined time period based on a time point at which the speech recognition function is activated.

It may be estimated that most context information necessary for understanding of the user's intention is included in dialogues held near to the time point at which the speech recognition function is activated. Therefore, it is possible to limit an analysis range of the content of the call to within a certain time period based on the time point when the speech recognition function is activated, reducing the load on the dialogue system 1 and shortening the time required for the analysis. After the information related to the content of the call is transmitted, all the information related to the content of the call stored in the storage 270 of the user terminal 2 may be deleted.

The communicator 160 of the dialogue system 1 receives the user's speech and the information related to the content of the call that are transmitted from the user terminal 2 (1210), and the preprocessing module 110 of the dialogue system 1 performs preprocessing on the received user's speech (1220).

The preprocessing module 110 may perform noise removal on the user's speech transmitted in a form of the audio signal, and perform end point detection (EPD). When an end point is detected, an end point detection signal indicating that the end point is detected may be transmitted to the user terminal 2 through the communicator 160.

Upon receiving the end point detection signal, the user terminal 2 may close the second channel and deactivate the speech recognition function.

The speech recognition module 120 may convert the user's speech on which the preprocessing is performed into text (1230). Here, the user's speech is a speech input by the user after the speech recognition function is activated, and may include a voice command.

Meanwhile, when the information related to the content of the call is received in a form of the audio file, the speech recognition module 120 may also convert the audio signal including the information related to the content of the call into text. That is, the user's speech and the counterpart's speech that are input during the call may be converted into text.

The natural language understanding module 130 and the dialogue management module 140 of the dialogue system 1 understands the user's intention based on the received user's speech and information related to the content of the call, and generates a system response (1230).

The natural language understanding module 130 may understand the user's intention based on the user's speech input after the speech recognition function is activated.

Furthermore, the natural language understanding module 130 may determine the context during the call based on the user's speech and the counterpart's speech that are included in the information related to the content of the call.

The dialogue management module 140 may generate an appropriate system response based on the user's intention and the context during the call that are determined by the natural language understanding module 130. For example, when it is difficult to accurately determine the user's intention only with the user's speech input after the speech recognition function is activated, the user's intention corresponding to the user's speech may be accurately specified using the context during the call. Therefore, it is not necessary to generate a system speech for specifying the user's intention.

As an exemplary embodiment of the present disclosure, when the user's intention is determined but entities required to perform a function corresponding to the intention are not all included in the user's speech, necessary entities may be obtained from the context during the call. Therefore, it is not necessary to generate a system speech for inquiring the required entity.

The communicator 160 of the dialogue system 1 re-transmits the generated system response to the user terminal 2 (1250).

The communicator 240 of the user terminal 2 receives the system response (1090).

When the received system response is a response for the content of the call (YES in 1100), the communicator 240 may transmit the system speech to the counterpart so that the call counterpart can hear the system speech (1110). The speaker 220 may output the system speech (1120). Although the received system response is illustrated as being transmitted to the counterpart first due to the characteristics of the flowchart, the transmission of the system speech to the call counterpart and the output of the system speech through the speaker 220 may be performed simultaneously, or the output of the system speech through the speaker 220 may be performed first.

When the received system response is not a response for the content of the call and the response (NO in 1100), the controller 250 of the user terminal 2 may output the system speech through the speaker 220 without transmitting the system speech to the counterpart (1120).

When the system speech is not a speech related to the content of the call, the call counterpart does not need to hear the system speech. Therefore, in the instant case, the system speech may be output only through the speaker 220 without being transmitted to the call counterpart.

Furthermore, since the first channel is closed, even when the system speech output through the speaker 220 is input through the microphone 210, the input system speech is not transmitted to the counterpart.

Furthermore, since the second channel is closed by end point detection, even when the system speech output through the speaker 220 is input through the microphone 210, the input system speech is not transmitted to the dialogue system 1.

Meanwhile, whether the system response is a response for the content of the call may be transmitted from the dialogue system 1. For example, the dialogue management module 140 of the dialogue system 1 may determine a relevance between the information related to the content of the call and the user's second speech or between the information related to the content of the call and the system speech through a keyword comparison or the like.

After the system speech is output, the first channel may be re-opened, and the user may resume the call with the counterpart.

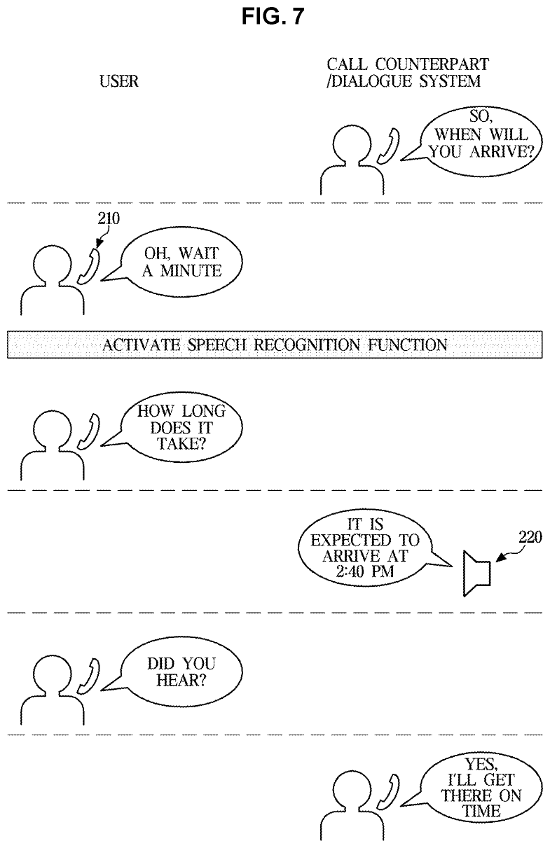

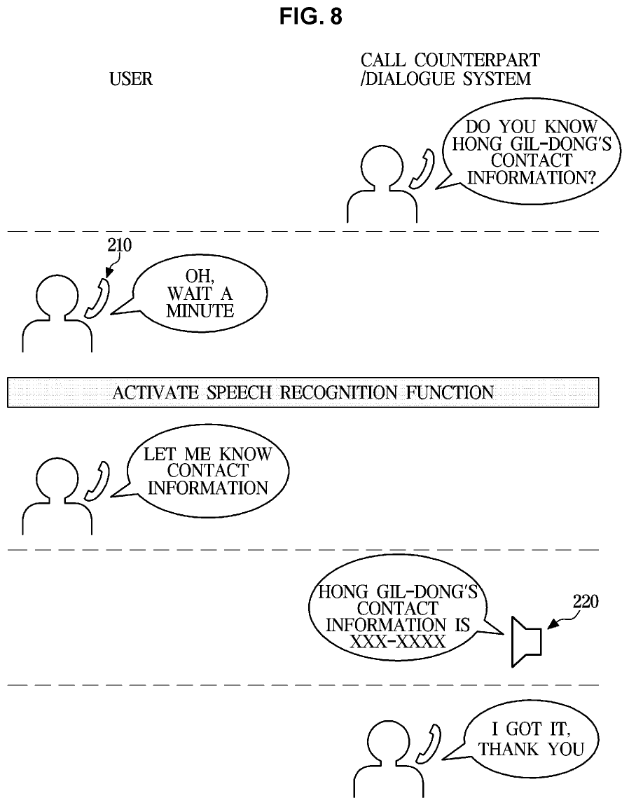

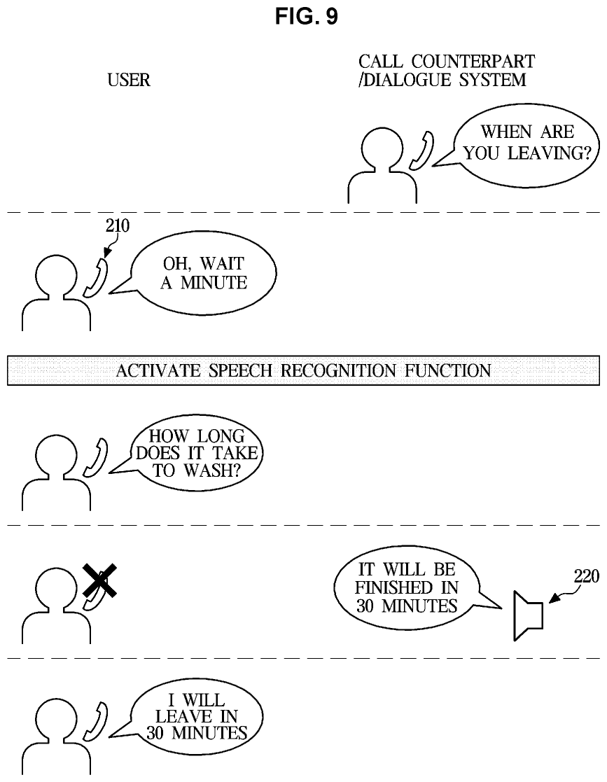

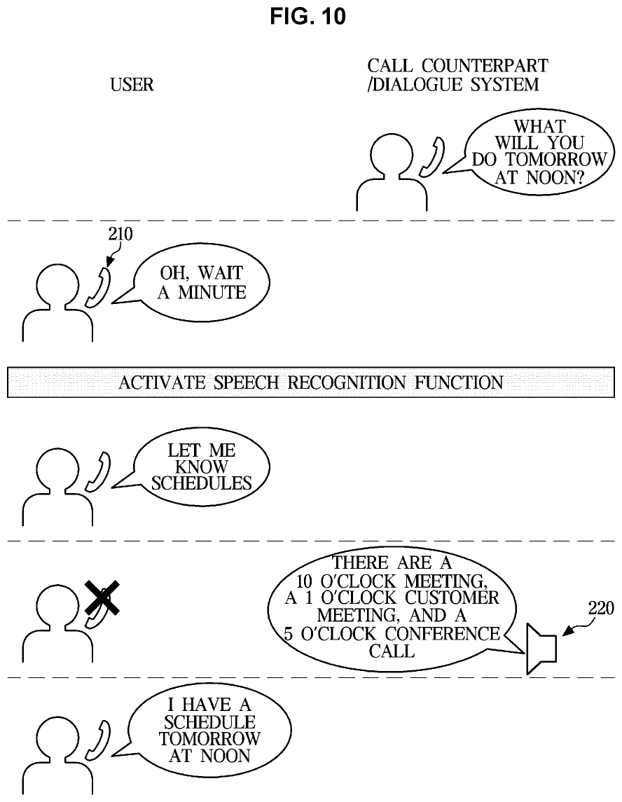

FIG. 7, FIG. 8, FIG. 9 and FIG. 10 are diagrams illustrating specific examples in which a user of a user terminal utilizes a speech recognition function while a call function is performed according to an exemplary embodiment of the present disclosure.

In the examples of FIG. 7, FIG. 8, FIG. 9 and FIG. 10, a case in which the user utilizes a speech recognition function during a call with the counterpart using the user terminal 2 is exemplified.

Referring to FIG. 7, during a call, a counterpart may input a speech “So, when will you arrive?” indicating that the counterpart asks for a user's arrival time, and in response, the user may input a speech “Oh, wait a minute” to check the arrival time.

A trigger signal for activating a speech recognition function may include a predetermined specific word spoken by the user to the counterpart during the call. In the present example, the speech “Oh, wait a minute” may function as a wake-up word for activating the speech recognition function.

To the present end, the controller 250 may additionally store an auxiliary wake-up word used only during the call in addition to a main wake-up word for activating the speech recognition function.

The auxiliary wake-up word may be set to a default and informed to the user or may be set by reflecting the user's language habit. For example, when a specific pattern of speech such as “Wait a minute” or “Wait” spoken by the user to the counterpart is input before the user speaks the main wake-up word during the call, the controller 250 may set the specific pattern of speech as the auxiliary wake-up word.

In the present example, when the speech “Oh, wait a minute” is input, the controller 250 may activate the speech recognition function. As the speech recognition function is activated, a first channel is closed, and the user's speech input through the microphone 210 may be transmitted to the dialogue system 1 through a second channel.

Meanwhile, information related to content of dialogue transmitted and received between the user and the counterpart during the call, that is, information related to content of the call may be stored in the storage 270. When the speech recognition module 280 is mounted on the user terminal 2, the user's speech and the counterpart's speech forming the content of the call may be converted into text. Therefore, the information related to the content of the call may be stored in a form of text.

When the speech recognition module 280 is not mounted on the user terminal 2 or the performance thereof is lowered even when the speech recognition module 280 is mounted on the user terminal 2, the information related to the content of the call may be stored in a form of an audio signal.

When the speech recognition function is activated and the user inputs a speech “How long does it take?” to inquire about the arrival time, the input user's speech may be transmitted to the dialogue system 1 through the second channel. In the instant case, the information related to the content of the call may also be transmitted together with the input user's speech.

The natural language understanding module 130 of the dialogue system 1 may understand that the user's intention corresponding to the user's speech is an inquiry about the destination arrival time. When a navigation function is currently performing, information on the destination arrival time may be received from a navigation service provider.

When the navigation function is not performing, the natural language understanding module 130 may extract information on a destination from the information related to the content of the call, and the dialogue management module 140 may obtain information on the arrival time to the extracted destination.

The dialogue management module 140 may generate a system speech for informing of the destination arrival time and transmit the system speech to the user terminal 2 through the communicator 160.

Upon receiving the system speech, user terminal 2 may output a system speech “It is expected to arrive at 2:40 pm” through the speaker 220.

Meanwhile, in the present example, the system speech including the information on the destination arrival time is a response for the call counterpart's inquiry, and may be regarded as related to the content of the dialogue transmitted and received between the user and the counterpart during the call. When the system speech is transmitted to the user terminal 2, the dialogue management module 140 may transmit information indicating a relevance between the system speech and the content of the call together with the system speech.

Because the system speech is related to the content of the call, the user terminal 2 may transmit the system speech received from the dialogue system 1 to the call counterpart. The counterpart's terminal may output the received system speech, and when the user hears the system speech output through the speaker 220, the counterpart may also hear the system speech output through the terminal.

Therefore, the user does not need to re-speak the information included in the system speech to the counterpart, and may conveniently share the information transmitted from the dialogue system 1.

Meanwhile, the first channel may be re-opened after the speech recognition function is deactivated and the second channel is closed, or may be opened after the system speech is output from the speaker 220 to avoid audio overlapping.

Referring to the example of FIG. 8, during the call, the counterpart may input a speech “Do you know Hong Gil-dong's contact information?” indicating that the counterpart asks for someone's contact information, and in response, the user may input a speech “Oh, wait a minute” to check Hong Gil-dong's contact information.

As described above, the speech “Oh, wait a minute” may function as a wake-up word for activating the speech recognition function. Therefore, when the speech “Oh, wait a minute” is input, the controller 250 may activate the speech recognition function. As the speech recognition function is activated, the first channel may be closed, and the user's speech input through the microphone 210 may be transmitted to the dialogue system 1 through the second channel.

When the user inputs a speech “Let me know contact information” to inquire about Hong Gil-dong's contact information, the input user's speech may be transmitted to the dialogue system 1 through the second channel. In the instant case, the information related to the content of the call may also be transmitted together with the input user's speech.

The natural language understanding module 130 of the dialogue system 1 may understand that the user's intention corresponding to the user's speech is an inquiry about the contact information. Although the user's speech does not include information on whose contact information the user is inquiring about, the dialogue management module 140 may determine that the contact information inquired by the user is Hong Gil-dong's contact information based on the information related to the content of the call.

The dialogue management module 140 may generate a system speech for informing of Hong Gil-dong's contact information and transmit the system speech to the user terminal 2 through the communicator 160.

Upon receiving the system speech, the user terminal 2 may output a system speech “Hong Gil-dong's contact information is XXX-XXXX” through the speaker 220.

Similarly, in the present example, the system speech including the information on Hong Gil-dong's contact information is a response for the counterpart's inquiry, and may be regarded as related to content of dialogue transmitted and received between the user and the counterpart during the call.

Because the system speech is related to the content of the call, the user terminal 2 may transmit the system speech received from the dialogue system 1 to the call counterpart. The counterpart's terminal may output the received system speech, and when the user hears the system speech output through the speaker 220, the counterpart may also hear the system speech output through the terminal.

In the example of FIG. 9, it is assumed that, during a call, the counterpart inputs a speech to ask the user when to leave and the user inputs a speech “Oh, wait a minute” in response thereto.

As described above, the speech “Oh, wait a minute” may function as a wake-up word for activating the speech recognition function. Therefore, when the speech “Oh, wait a minute” is input, the controller 250 may activate the speech recognition function. As the speech recognition function is activated, the first channel may be closed, and the user's speech input through the microphone 210 may be transmitted to the dialogue system 1 through the second channel.

When the user inputs a speech “How long does it take to wash?” to inquire about a time it takes to complete washing, the input user's speech may be transmitted to the dialogue system 1 through the second channel. In the instant case, the information related to the content of the call may also be transmitted together with the input user's speech.

The natural language understanding module 130 of the dialogue system 1 may understand that the user's intention corresponding to the user's speech is an inquiry about a time required for washing. For example, the dialogue management module 140 may obtain information on a time required for the washing machine to finish washing from a home network system built in the user's premises.

The dialogue management module 140 may generate a system speech for informing of the time required for washing to be finished and transmit the system speech to the user terminal 2 through the communicator 160.

Upon receiving the system speech, the user terminal 2 may output a system speech “It will be finished in 30 minutes” through the speaker 220.

In the present example, the system speech is not related to content of dialogue transmitted and received between the user and the counterpart during the call. Therefore, the user terminal 2 does not transmit the system speech transmitted from the dialogue system 1 to the call counterpart. Furthermore, since the first channel is also closed, even when the system speech output through the speaker 220 is input through the microphone 210, the system speech is not transmitted to the call counterpart.

When the output of the system speech through the speaker 220 is completed, the controller 250 may re-open the first channel. Therefore, the user's speech “I will leave in 30 minutes” which is input through the microphone 210 may be transmitted to the counterpart through the first channel.

Meanwhile, even when the system speech is related to the content of the call, it is possible not to share the system speech with the counterpart according to the user's selection. For example, it is possible to preset whether the system speech output during the call is shared with the counterpart, and when the speech recognition function is performed during the call, it is also possible to display a screen for selecting whether the system speech is shared on the display 230.

In the example of FIG. 10, it is assumed that the user does not select to share a system speech with the counterpart.

Referring to the example of FIG. 10, during the call, the counterpart may input a speech “What will you do tomorrow at noon?” to ask to the user for tomorrow's schedule, and in response, the user may input a speech “Oh, wait a minute.”

As described above, the speech “Oh, wait a minute” may function as a wake-up word for activating the speech recognition function. Therefore, when “the speech “Oh, wait a minute” is input, the controller 250 may activate the speech recognition function. As the speech recognition function is activated, the first channel may be closed, and the user's speech input through the microphone 210 may be transmitted to the dialogue system 1 through the second channel.

When the user inputs a speech “Let me know schedules” to ask about tomorrow's schedule, the input user's speech may be transmitted to the dialogue system 1 through the second channel. In the instant case, the information related to the content of the call may also be transmitted together with the input user's speech.

The natural language understanding module 130 of the dialogue system 1 may understand that the user's intention corresponding to the user's speech is an inquiry about the schedule. Although the user's speech does not include information on when to inquire about the schedule, the dialogue management module 140 may determine that the schedule inquired by the user is tomorrow's schedule based on the information related to the content of the call.

The dialogue management module 140 may generate a system speech for informing of the tomorrow's schedule and transmit the system speech to the user terminal 2 through the communicator 160.

Upon receiving the system speech, the user terminal 2 may output a system speech “There are a 10 o'clock meeting, a 1 o'clock customer meeting, and a 5 o'clock conference call” through the speaker 220.

The system speech including the information on the tomorrow's schedule is a response for the counterpart's inquiry, and may be regarded as related to content of dialogue transmitted and received between the user and the counterpart during the call. However, since the user does not select to share the system speech, the user terminal 2 does not transmit the system speech transmitted from the dialogue system 1 to the call counterpart. Furthermore, since the first channel is closed, even when the system speech output through the speaker 220 is input through the microphone 210, the system speech is not transmitted to the call counterpart.

When the output of the system speech through the speaker 220 is completed, the controller 250 may re-open the first channel. Therefore, the user's speech “I have a schedule tomorrow at noon” which is input through the microphone 210 may be transmitted to the counterpart through the first channel.

Hereinafter, in a method of controlling the user terminal and a dialogue management method according to an exemplary embodiment of the present disclosure, an example in which a system response is preemptively generated and output based on a call-related content will be described.

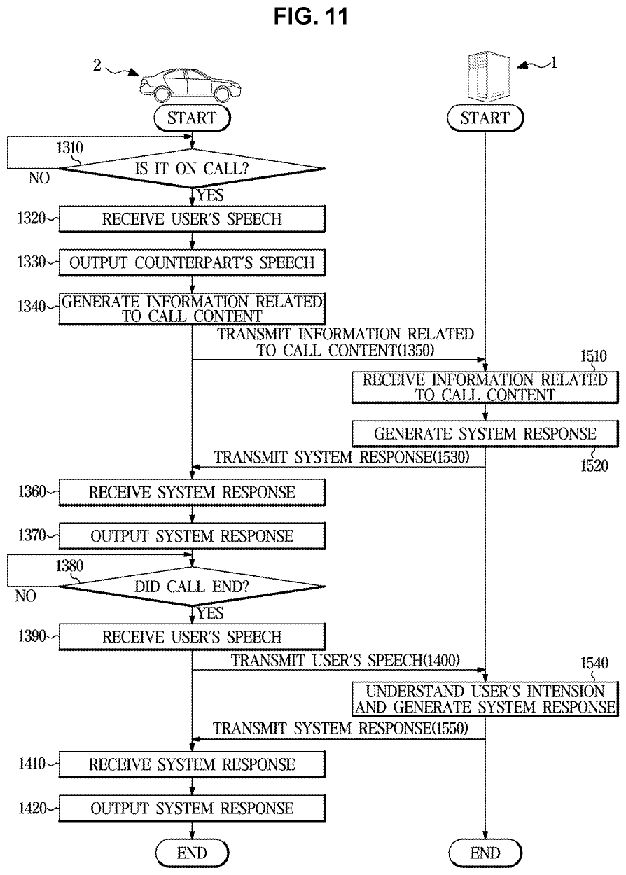

FIG. 11 is a flowchart illustrating another example of the method of controlling the user terminal and the dialogue management method according to the embodiment.

In FIG. 11, the flowchart illustrated under the user terminal 2 is a flowchart illustrating the method of controlling the user terminal, and the flowchart illustrated under the dialogue system 1 is a flowchart illustrating the dialogue management method.

Referring to FIG. 11, when the user terminal 2 is performing a call function (YES in 1310), the microphone 210 receives the user's speech (1320) and the speaker 220 outputs the counterpart's speech (1330).

The user's speech input through the microphone 210 may be transmitted to the counterpart through the communicator 240, and when the communicator 240 receives the speech from the counterpart, the counterpart's speech may be output through the speaker 220.

Furthermore, the user terminal 2 may generate information related to content of a call (1340) and transmit the generated information to the dialogue system 1 (1350).

In the above-described example, when a speech recognition function is activated, the information related to the content of the call is transmitted to the dialogue system 1. However, in the present example, the information related to the content of the call may be transmitted to the dialogue system 1 before the speech recognition function is activated.

To the present end, the user may pre-select whether the information related to the content of the call is transmitted. It is possible to pre-select one from among setting items of the user terminal 2, and when a call starts, it is also possible to display a screen for selecting whether the information related to the content of the call is transmitted to the dialogue system 1 on the display 230.

In the present example, it is assumed that the user selects to transmit the information related to the content of the call in any way.

The dialogue system 1 may receive the information related to the content of the call (1510), and in response, generate a system response (1520).

The natural language understanding module 130 may extract information on the user's intention and the counterpart's intention, entities included in the speech, and the like, based on the user's speech and the counterpart's speech that are included in the information related to the content of the call.

The dialogue management module 140 may predict the user's intention based on the output of the natural language understanding module 130, and in response, proactively generate a system response. For example, when the user is expected to move to a specific destination based on the content of the dialogue transmitted and received between the user and the counterpart during the call, a system response for asking whether to perform route guidance to the corresponding destination may be generated.

As an exemplary embodiment of the present disclosure, when a call to a specific counterpart is expected based on the content of the dialogue transmitted and received between the user and the counterpart during the call, a system response for asking whether to call the corresponding counterpart may be generated.

The communicator 160 of the dialogue system 1 transmits the generated system response to the user terminal 2 (1530).

The user terminal 2 receives the system response (1360), and outputs the received system response through the display 230 (1370).

When the call ends (YES in 1380), the user may input a speech related to the system response to the microphone 210 (1390).

For example, when the system response includes an inquiry about whether to receive a specific service, the speech related to the system response input by the user may include a response to whether to receive the corresponding service.

Since the system response is proactively output, even when the user does not input an additional trigger signal, the speech recognition function may be activated at the same time as the call ends, and the user's speech which is input after the call ends may be transmitted to the dialogue system 1 (1400).

The communicator 160 of the dialogue system 1 may receive the user's speech, the natural language understanding module 130 may understand the user's intention based on the received user's speech, and the dialogue management module 140 may generate the system response corresponding to the user's intention (1540).

When the user's intention is to receive a service proactively suggested by the dialogue system 1, a new system response generated in response thereto may be related to the corresponding service.

When the user's intention is not to receive the service proactively suggested by the dialogue system 1, a new system response generated in response thereto may include a system speech indicating that the user's intention is understood.

Alternatively, when the user's intention is not related to the service proactively suggested by the dialogue system 1, a system response generated in response thereto may be related to the user's intention.

Alternatively, only when the user's speech which is input after the call ends is related to the service proactively suggested by the dialogue system 1, a system response is generated in response thereto, and thus it is also possible to prevent a system response from being generated even with respect to the input user's speech regardless of the speech recognition function.

According to the performance of the speech recognition module 280 provided in the user terminal 2, whether the user's speech is related to the service proactively suggested by the dialogue system 1, that is, whether the user's speech is related to the system response proactively generated by the dialogue system 1, may be determined by the user terminal 2 or the dialogue system 1.

In the former case, when the user's speech is not related to the system response proactively generated by the dialogue system 1, the user terminal 2 does not transmit the user's speech to the dialogue system 1.

In the latter case, when the user's speech is not related to the system response proactively generated by the dialogue system 1, the dialogue system 1 does not generate a system response corresponding to the user's speech.

When the dialogue system 1 generates and transmits the system response corresponding to the user's speech, the user terminal 2 receives the system response (1410) and output the system response (1420).

The system response may be output through the speaker 220 or through the display 230 according to a type thereof.

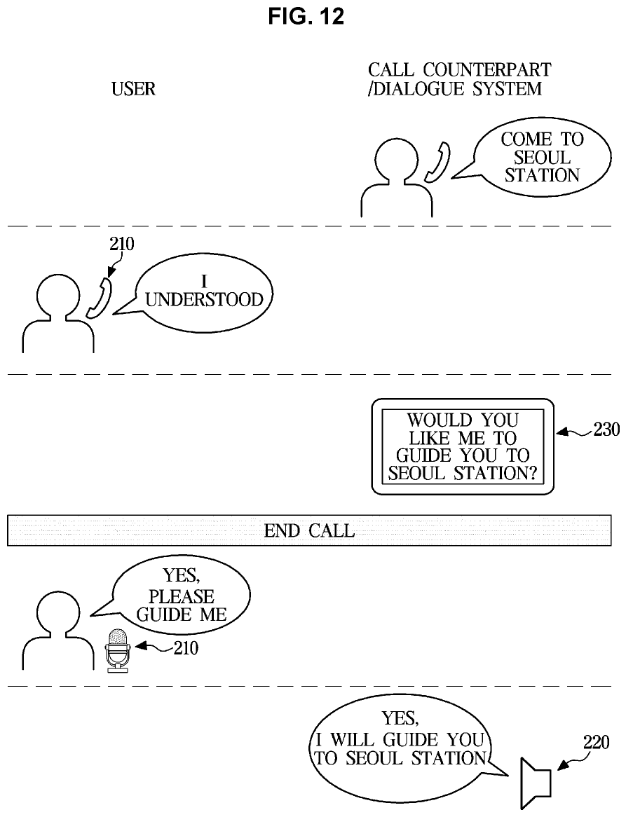

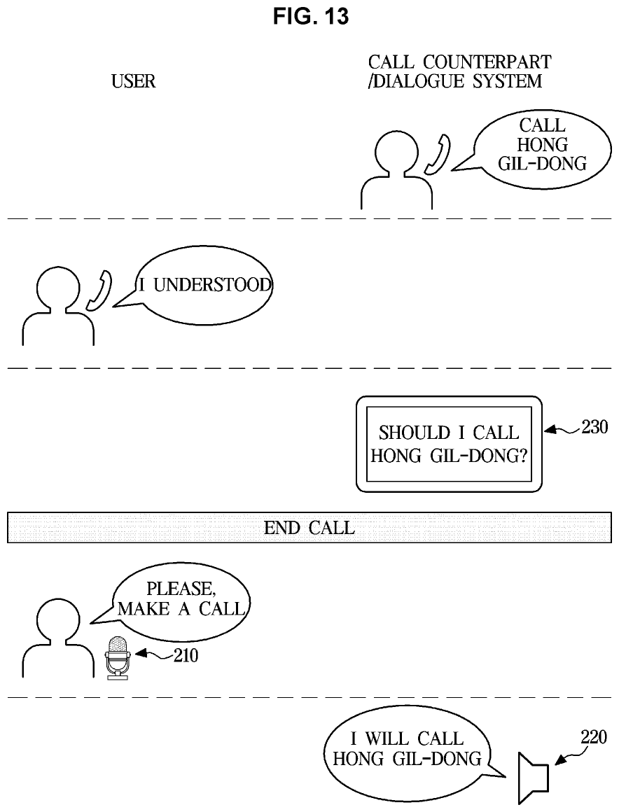

FIG. 12, and FIG. 13 are diagrams illustrating specific examples in which a system response is proactively provided while a user of a user terminal utilizes a call function according to an exemplary embodiment of the present disclosure.

In the examples of FIG. 12, and FIG. 13, it is assumed that the user allows the information related to the content of the call to be transmitted to the dialogue system 1.

According to the example of FIG. 12, during the call, a speech “Come to Seoul Station” indicating that the counterpart requests the user to come to a specific destination may be input, and in response, a speech “I understood” indicating that the user agrees may be input.

The information related to the content of the call including the user's speech and the counterpart's speech may be transmitted to the dialogue system 1, and the natural language understanding module 130 may determine that a function predicted to be executed by the user after the call ends is to guide a route to Seoul Station, based on the user's speech and the counterpart's speech.

The dialogue management module 140 may generate a system response for asking whether to perform route guidance to Seoul Station. In the instant case, since the user is on a call and has not spoken a wake-up word for activating the speech recognition function, the system response may be generated to be visually output.

The generated system response may be transmitted to the user terminal 2, and the user terminal 2 may visually output the transmitted system response to the display 230. Even before the call ends, the user may check a message “Would you like me to guide you to Seoul Station?” displayed on the display 230.

When the call ends, the speech recognition function may be activated. That is, the user's speech input through the microphone 210 may be transmitted to the dialogue system 1 even when the user does not input an additional trigger signal.

In the present example, since the user inputs a speech “Yes, please guide me” indicating that the user requests for route guidance to Seoul Station, the dialogue system 1 may generate a speech “Yes, I will guide you to Seoul Station” to announce the start of route guidance to Seoul Station and transmit the generated speech to the user terminal 2.

Upon receiving the system speech, the user terminal 2 may output the received system speech through the speaker 220.

According to the example of FIG. 13, during the call, the counterpart may input a speech “Call Hong Gil-dong” indicating that the counterpart proposes to the user to call another counterpart, and in response, the user may input a speech “I understood” indicating that the user agrees.

The information related to the content of the call including the user's speech and the counterpart's speech may be transmitted to the dialogue system 1, and the natural language understanding module 130 may determine that a function predicted to be executed by the user after the call ends is to call Hong Gil-dong, based on the user's speech and the counterpart's speech.

The dialogue management module 140 may generate a system response for asking whether to call Hong Gil-dong. In the instant case, since the user is on a call and has not spoken a wake-up word for activating the speech recognition function, the system response may be generated to be visually output.

The generated system response may be transmitted to the user terminal 2, and the user terminal 2 may visually output the transmitted system response to the display 230. Even before the call ends, the user may check a message “Should I call Hong Gil-dong?” displayed on the display 230.

When the call ends, the speech recognition function may be activated. That is, the user's speech input through the microphone 210 may be transmitted to the dialogue system 1 even when the user does not input an additional trigger signal.

In the present example, since the user inputs a speech “Please, make a call” to indicating that the user requests for making a call Hong Gil-dong, the dialogue system 1 may generate a speech “I will call Hong Gil-dong” to inform of the execution of a dialing function and transmit the generated speech to the user terminal 2.

Upon receiving the system speech, the user terminal 2 may output the received system speech through the speaker 220.

According to the examples of the user terminal, and the method controlling the same, the dialogue system, and the dialogue management method described until now, a user can conveniently and efficiently use a speech recognition function even during a call.

Meanwhile, the dialogue management method according to the disclosed exemplary embodiments of the present disclosure may be stored in a recording medium in a form of instructions executable by a computer. The instructions may be stored in a form of program code. When the instructions are executed by a processor, the operations of the disclosed exemplary embodiments of the present disclosure may be performed. The recording medium may be implemented as a non-transitory computer-readable recording medium.

Computer-readable recording media include all types of recording media in which instructions which may be decoded by a computer, are stored. For example, examples of the computer-readable recording media may include an ROM, an RAM, a magnetic tape, a magnetic disk, a flash memory, an optical data storage device, and the like.

According to the user terminal, the method of controlling the user terminal, and the dialogue management method, a user can conveniently use a speech recognition function as necessary even during a call, and a system response reflecting content of the call of the user may be provided.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A user terminal comprising:
a microphone through which a speech of a user is input;
a speaker through which a speech of a counterpart is output during a call;
a controller configured to activate a speech recognition function upon receiving a trigger signal during the call; and
a communicator configured to transmit information related to the speech of the user which is input through the microphone after the trigger signal is input and information related to content of the call to a dialogue system that is configured to perform the speech recognition function,
wherein the controller is further configured to control the speaker to output a system response transmitted from the dialogue system.

2. The user terminal of claim 1, further including a storage configured to store the information related to the content of the call.

3. The user terminal of claim 2, wherein the information related to the content of the call includes the speech of the user and the speech of the counterpart that are input during the call.

4. The user terminal of claim 3, wherein the storage is configured to store the information related to the content of the call in a form of an audio signal.

5. The user terminal of claim 3, further including a speech recognition module configured to convert the speech of the user and the speech of the counterpart that are input during the call into text.

6. The user terminal of claim 5, wherein the storage is configured to store the information related to the content of the call in a form of text.

7. The user terminal of claim 2, wherein the system response for the content of the call is generated based on the information related to the content of the call and the speech of the user which is input through the microphone after the trigger signal is input.

8. The user terminal of claim 1, wherein the communicator is further configured to transmit the speech of the user to the counterpart through a first channel and to transmit the speech of the user to the dialogue system through a second channel.

9. The user terminal of claim 8, wherein, the controller is further configured to close the first channel so that the speech of the user input through the microphone is not transmitted to the counterpart in response to the receiving the trigger signal.

10. The user terminal of claim 1, wherein the trigger signal includes a predetermined specific word spoken by the user to the counterpart during the call.

11. The user terminal of claim 3, wherein the controller is further configured to transmit the information related to the content of the call stored within a predetermined time period based on a time point at which the speech recognition function is activated to the dialogue system through the communicator.

12. The user terminal of claim 1, wherein the controller is further configured to control the communicator to transmit the system response to the counterpart in a case in which the system response is related to the content of the call.

13. The user terminal of claim 1, wherein the controller is further configured to control the communicator to transmit the system response to the counterpart according to selection of the user.

14. A method of controlling a user terminal, the method comprising:
receiving a speech of a user through a microphone;
outputting, through a speaker, a speech of a counterpart during a call;
storing information related to content of the call;
activating, by a controller, a speech recognition function upon receiving a trigger signal during the call;
transmitting information related to the speech of the user which is input through the microphone after the trigger signal is input and information related to the content of the call to a dialogue system that is configured to perform the speech recognition function; and
controlling, by the controller, the speaker to output a system response transmitted from the dialogue system.

15. The method of claim 14, further including transmitting the speech of the user input through the microphone during the call to the counterpart through a first channel of the communicator,
wherein the transmitting of the information to the dialogue system that is configured to perform the speech recognition function includes closing the first channel and transmitting the speech of the user to the dialogue system through a second channel of the communicator.

16. The method of claim 14, further including, in a case in which the system response is related to the content of the call, transmitting the system response to the counterpart through the communicator.

17. The method of claim 14, further including:
receiving a selection of the user as to whether to transmit the system response to the counterpart; and
transmitting the system response to the counterpart through the communicator based on the selection of the user.

18. A dialogue management method comprising:
receiving, from a user terminal, information related to content of a call between a user and a counterpart;
predicting an intention of the user based on the information related to the content of the call;
proactively generating a system response corresponding to the predicted intention of the user;
transmitting the system response to the user terminal;
in response to receiving a speech of the user related to the system response from the user terminal after the call ends, generating a new system response corresponding to the received speech of the user; and
transmitting the new system response to the user terminal.

19. The dialogue management method of claim 18, wherein, upon ending the call, the user terminal is configured to activate a speech recognition function.

20. The dialogue management method of claim 19, further including, after the call ends, determining whether the speech of the user received from the user terminal is related to the system response.
